(19) United States
(12) Patent Application Publication
(10) Pub. No.: US 2005/0016759 A1
(43) Pub. Date: Jan. 27, 2005

(54) High temperature superconducting devices and related methods

(76) Inventors: Alexis P. Malozemoff, Lexington, MA (US); Darren Verebelyi, Oxford, MA (US); John D. Scudiere, Bolton, MA (US)

Correspondence Address: FISH & RICHARDSON PC, 225 FRANKLIN ST, BOSTON, MA, 02110, US

(21) Appl. No.: 10/624,026

(22) Filed: Jul. 21, 2003

(51) Int. Cl. H01B 12/00

(52) U.S. Cl. 174/125.1

(57) ABSTRACT

High temperature superconducting devices and related methods are disclosed.

### TECHNICAL FIELD

The invention generally relates to high temperature superconducting devices and related methods.

### BACKGROUND

Multi-layer superconducting devices, such as wires, having various architectures have been developed. Such devices are often tape-shaped and include a substrate and a superconducting layer. Typically, one or more buffer layers are disposed between the substrate and the superconductor layer, with a stabilizing metal layer on the superconductor layer.

### SUMMARY

In general, the invention relates to high temperature superconducting devices and related methods.

In one aspect, the invention features a superconducting device that includes a first coated superconductor, a first metal layer supported by the first coated superconductor, and a second coated superconductor. The second coated superconductor is releasably bonded to the first metal layer so that when the device is heated to at least about a predetermined temperature, the first metal layer releases from the second coated superconductor without releasing the first metal layer from the first superconductor. Heating the superconducting device to at least about the predetermined temperature does not substantially change the critical current density of the first or second coated superconductor, (e.g., the critical current density remains substantially unchanged after heating the device to the predetermined temperature).

The first coated superconductor of the device can include a first non-superconductor layer and a first superconductor layer supported by the first non-superconducting layer. The second coated superconductor can include a second non-superconductor layer, a second superconductor layer supported by the second non-superconducting layer, and a second metal layer. The first and second metal layers can be bonded to their respective superconductor layers with an electrically conducting bond. Specifically, the first and second metal layers can be soldered, sonically bonded, thermal bonded, or vapor deposited on their corresponding superconductor layers.

The first and second coated superconductors can be bonded together with a solder such that the first metal layer of the first superconductor is adjacent to the second metal layer of the second superconductor.

The first and second metal layers can each comprise multiple layers. For example, the first metal layer can include a silver layer and a copper layer. The multiple metal layers can be vapor deposited on top of each other, thermally bonded together, sonically bonded together, or soldered together. If the multiple metal layers are soldered together, the solder used to bond the metal layers has a higher melting point temperature than the solder used to bond the first and second coated superconductors together. For example, the difference between the melting point temperatures between the two solders can be at least about 5° C. (e.g., at least about 10° C., at least about 15° C., at least about 25° C., etc.).

In some embodiments, the first non-superconducting layer includes a substrate, such as a nickel alloy substrate (e.g., Ni—W).

In some embodiments, the first non-superconducting layer includes at least one buffer layer deposited on a substrate.

In certain embodiments, the first and second superconducting layers are formed from a high temperature superconductor with a transition temperature above about 30 Kelvin. For example, rare earth oxides, such as YBCO, are high temperature superconductors having a transition temperature above about 30 Kelvin.

In certain embodiments, two or more superconductors (e.g., coated superconductors) can be separated from each other without substantially changing the critical current density of the individual superconductors.

In another aspect, the invention features a superconducting device that includes a first coated superconductor, a second coated superconductor, and a metallic paste, such as a silver paste. The metallic paste releasably bonds the first coated superconductor to the second coated superconductor to form an interface between the two superconductors. This bond can be removed, for example, by simply peeling the two superconductors apart. The critical current density of each of the first and second coated superconductors remains substantially unchanged after peeling a portion of the first coated superconductor way from the interface.

In another aspect, the invention features a superconducting device including two coated superconductors releasably bonded together and which can be separated by subjecting the device to a solution formulated to dissolve a bond between the two coated superconductors. The critical current density of each of the first and second coated superconductors remains substantially unchanged after subjecting the device to the solution.

In another aspect, the invention features a method of splicing superconducting devices. The method includes providing a first superconducting device that has a first coated superconductor, which is releasably bonded to a second coated superconductor, providing a second coated superconducting device that includes a third coated superconductor releasably bonded to a fourth coated superconductor, removing a first length of the second coated superconductor, removing a complementary length of the third coated superconductor, and joining the first and second superconducting devices to form an interface between the first and fourth coated superconductors.

In some embodiments, the interface between the first and fourth coated superconductor is electrically conductive.

In some embodiments, the first coated superconductor is released from the second coated superconductor when the first superconducting device is heated to at least about a predetermined temperature.

In certain embodiments, the third coated superconductor is released from the fourth coated superconductor when the second superconducting device is heated to at least about a predetermined temperature.

In some embodiments, the first length is removed by heating the first superconducting device to at least about the predetermined temperature and cutting the second coated superconductor from an exposed surface of the second coated superconductor to an interface between the first and second coated superconductors.

In certain embodiments, the complementary length is removed by heating the second superconducting device to at least about the predetermined temperature to release at least a portion of the third coated superconductor from the fourth coated superconductor and cutting the third coated superconductor from an exposed surface of the third coated superconductor to an interface between the third and fourth coated superconductors.

In some embodiments, applying a chemical agent to the first superconducting device releases the first coated superconductor from the second coated superconductor.

In another aspect, the invention features a superconducting device that includes a first coated superconductor, a second coated superconductor, and an electrically conducting element. The first and second coated superconductors are bonded in a first region of the device and are unbonded in a second region of the device. The electrically conducting element is disposed within the second region and is in electrical communication with both the first and second coated superconductors.

In some embodiments, the second coated superconductor is releasably bonded to the first coated superconductor in the first region.

In certain embodiments, the electrically conducting element comprises metal, such as copper.

In some embodiments, the electrically conducting element comprises a superconducting article.

In some embodiments, the electrically conducting element comprises metal and at least one superconducting article.

In certain embodiments, the electrically conducting element has a triangular cross-sectional shape. In other embodiments the electrically conducting element has a diamond cross-sectional shape. In other embodiments, the electrically conducting element has a square cross-sectional shape. In another embodiment, the electrically conducting element has a rectangular cross-sectional shape. In another embodiment, the electrically conducting element has a hexagonal cross-sectional shape. In other embodiments, the electrically conducting element has a trapezoidal cross-sectional shape.

In some embodiments, the superconducting device can further include a third coated superconductor and a fourth coated superconductor. The fourth coated superconductor is bonded to the third coated superconductor in a third region of the device, and is unbonded to the third coated superconductor in the second region of the device. The third and fourth coated superconductors can be in electrical communication with the electrically conducting element in the second region.

In some embodiments, the first coated superconductor is in contact with the third coated superconductor in the second region.

In certain embodiments, the second coated superconductor is in contact with the fourth coated superconductor in the second region.

In some embodiments, the first coated superconductor has a greater length than the second coated superconductor in the second region.

In another aspect, the invention features a method of cutting a superconducting device that includes first and second superconductors which are releasably bonded to each other. The method includes cutting the superconducting device so that the first coated superconductor, the second coated superconductor and an interface between the first and second coated superconductors are exposed, heating the first superconductor to at least about a predetermined temperature so that a first length of the first coated superconductor releases from the second coated superconductor, and removing the first length from the first coated superconductor so that an end of the first coated superconductor is offset from an end of the second coated superconductor.

In some embodiments, a second length of the second coated superconductor is also removed from the device. The second length is less than the first length.

In some embodiments, a critical current density of the first coated superconductor remains substantially unchanged after heating the superconducting device to at least about the predetermined temperature.

In certain embodiment, a critical current density of the second coated superconductor remains substantially unchanged after heating the superconducting device to at least about the predetermined temperature.

In another aspect, the invention features a method of joining a first coated superconductor to a second coated superconductor. The method includes removing a first portion of a first metallic layer that is releasably bonded to the first coated superconductor, removing a complementary portion of the second coated superconductor, removing a second portion of the first coated superconductor, removing a complementary portion of a second metallic layer that is releasably bonded to the second coated superconductor, and joining the first and second coated superconductors such that a stepped interface is formed therebetween.

In another aspect, the invention features, a superconducting device including a first article and a second article joined along a stepped interface. The first article includes a first superconductor and a first metal layer releasably bonded to the first superconductor. The second article includes a second superconductor and a second metal layer releasably bonded to the second superconductor.

In some embodiments, the first metal layer is formed of multiple metal layers.

In certain embodiments, the second metal layer is formed of multiple metal layers.

In some embodiments, the device further includes a first non-superconducting layer bonded to the first coated superconductor.

In certain embodiments, the device further includes a second non-superconducting layer bonded to the second coated superconductor.

In some embodiments, two or more superconductors (e.g., coated superconductors) can be relatively easily separated such that connection sites can subsequently be formed at any position along the superconductors.

In certain embodiments, two or more superconductors (e.g., coated superconductors) can be cut and joined relatively easily to, for example, an electrically conductive device (e.g., a metallic device, a superconducting device).

Features and advantages of the invention are in the description, drawings and claims.

### DESCRIPTION OF DRAWINGS

FIG. 1 is a cross-sectional view of an embodiment of a superconducting device;

FIG. 2 is cross-section view of a connection site formed in a portion of the superconducting device of FIG. 1;

FIG. 3A is cross-sectional view of an embodiment of two superconducting devices prior to splicing the devices;

FIG. 3B is a cross-sectional view of an embodiment of two superconducting devices after removing a portion from each superconducting device;

FIG. 3C is a cross-sectional view of an embodiment of two superconducting device after splicing together the two superconducting devices;

FIG. 4A is a cross-sectional view of an embodiment of two superconducting tapes prior to attachment;

FIG. 4B is a cross-sectional view of an embodiment of the two tapes after removing a portion from each of the tapes;

FIG. 4C is a cross-sectional view of an embodiment of the two tapes after attachment;

FIG. 5 is a cross-sectional view of an embodiment of a connection between two spliced superconducting devices;

FIG. 6 is a cross-sectional view of an embodiment of a connection between two spliced superconducting devices; and

FIG. 7 is a cross-sectional view of an embodiment of a superconducting device connected to a terminal.

Like reference symbols in the various drawings indicate like elements.

### DETAILED DESCRIPTION

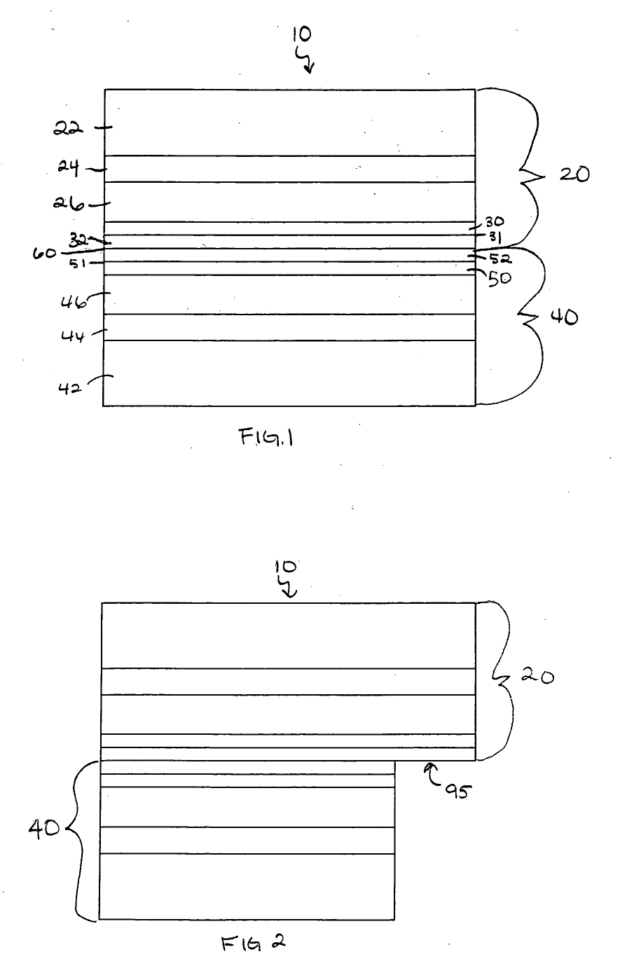

FIG. 1 shows a cross-sectional view of an embodiment of a superconducting device 10 that includes coated superconductor tapes 20 and 40 and a solder layer 60 bonding tapes 20 and 40. Tape 20 includes a Ni—W alloy substrate 22, a buffer layer stack 24, a YBCO superconducting layer 26, a silver layer 30, a copper layer 32 and a solder layer 31 bonding layers 30 and 32. Similarly, tape 40 includes a Ni—W alloy substrate 42, a buffer layer stack 44, a YBCO superconducting layer 46, a silver layer 50, a copper layer 52 and a solder layer 51 bonding layers 50 and 52.

The material used to form solder layer 60 has a lower melting point than the material used to form layer 31 and the material used to form layer 51. In certain embodiments, the melting point of the material used to form solder layer 60 is at least about 5° C. (e.g., at least about 10° C., at least about 15° C., at least about 20° C., at least about 25° C.) less than the melting point of the material used to form layer 31 and the material used to form layer 51.

With this arrangement tapes 20 and 40 can be relatively easily separated by heating device 10 to a temperature and for a period of time sufficient to melt at least a portion of layer 60 without substantially melting layers 31 and 51. As an example, in some embodiments, device 10 can be heated to a temperature that is at least about the melting point of the material used to form layer 60, but less than the melting point of the material used to form layer 31 and the material used to form layer 51. As another example, in certain embodiments, device 10 can be heated to a temperature that is at least about the melting point of layers 31 and/or 51 but for a period of time that is sufficient to melt layer 60 without substantially melting layers 31 or 51.

Because the conditions used to heat device 10 are selected so that layers 31 and 51 are not substantially melted, the process of separating tapes 20 and 40 allows the tapes to remain substantially intact, thereby allowing tapes 20 and 40 to undergo separation without a substantial change in their individual critical current densities. For example, in some embodiments, the critical current density of tape 20 after separation is at least about 90% (e.g., at least about 95%, at least about 99%) of the critical current density of tape 20 before separation, and/or the critical current density of tape 40 after separation is at least about 90% (e.g., at least about 95%, at least about 99%) of the critical current density of tape 40 before separation.

In general, layer 60 is formed of a material with a melting point that is low enough so that, when device 10 is heated to separate tapes 20 and 40, the critical current density of layers 20 and 40 is substantially unchanged. In some embodiments, layer 60 is formed of a material that has a melting point of at most about 200° C. (e.g., at most about 150° C., at most about 125° C., at most about 100° C.). Examples of materials from which layer 60 can be formed include tin-silver alloys, indium-tin alloys, indium, and Bi 56 wt %/Pb 22 wt %/Sn 22 wt %. Examples of such commercially available materials include Indalloy 4 and Indalloy 1E, both manufactured by Indium Corporation of America (Utica, N.Y.).

In general, the material used to form layer 31 can be the same as or different from the material used to form layer 51. Examples of materials from which layers 31 and 51 can be formed include tin-lead alloys, such as Sn 62 wt %/Pb 36 wt %/Ag 2 wt %, lead-indium alloys, such as Pb 75 wt %/In 25 wt %, and tin-silver alloys, such as Sn 95 wt %/Ag 5 wt %.

In general, the materials used to form layers 31, 51 and 60 are electrically conductive. As a result, electric current can move relatively freely between the tapes 20 and 40, which can enhance both the electrical stability and/or the current carrying capacity of device 10 compared to superconducting devices including tapes that are not in electrical communication with each other. For example, the architecture or stacking order of device 10 can allow electric current to readily propagate along and between tapes 20 and 40, even if a localized defect such as a crack or a grain boundary is present in one of the superconducting layers 26 and 46. In the case that a localized defect is present in superconducting layer 26, electrical current in the vicinity of the defect can, for example, be shunted through layers 30, 31, 32, 60, and optionally through layers 52, 51, 50, and/or superconducting layer 46.

Moreover, as shown in FIG. 2, by releasably bonding (e.g., soldering) the two tapes 20 and 40 together, the tapes can be readily separated to allow the formation of a connection site 95 at a desired location along the length of one of tapes 20 and 40. In order to splice together two different superconducting devices, an interface having a length long enough to transfer current between the two devices is formed to electrically connect the two devices together. Thus, connection sites that provide surface area to form a longitudinal connection between superconducting tapes belonging to two different superconducting devices are formed in each device. By being able to easily remove tape 20 from tape 40, one can easily form a connection site at any location along device 10.

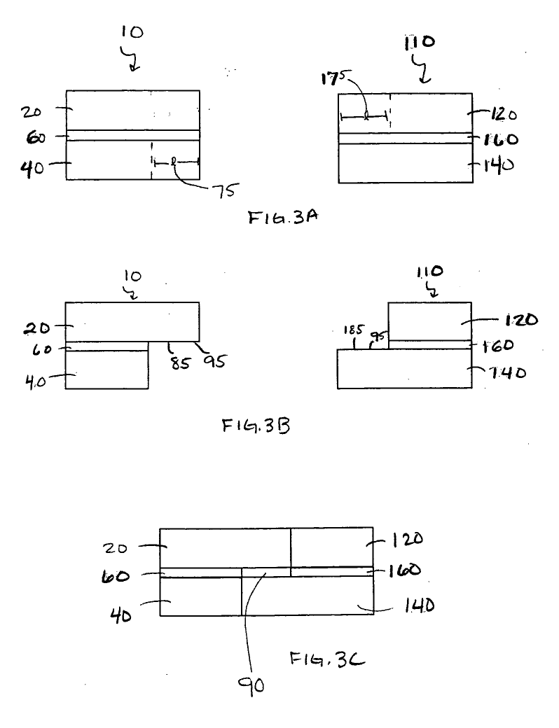

FIGS. 3A-3C show a method of splicing device 10 to a second device 110. Device 110 includes superconducting tapes 120 and 140. Similar to device 10, tapes 120 and 140 in device 110 are releasably bonded to each other by a solder layer 160 located therebetween. The individual layers within tapes 120 and 140 are as described above with respect to tapes 20 and 40. To splice (combine) devices 10 and 110 together, a first portion 75 from tape 40 and a portion 175 of complimentary length from tape 120 are removed, resulting in the formation of an exposed portion 85 of tape 20 and an exposed portion 185 of tape 140. An appropriate amount of solder (e.g., formed of the material of layer 60 and/or layer 160) is disposed along exposed portion 85 and/or 185. Devices 10 and 110 are then brought into physical contact, and joined along a solder layer 90 by heating and then cooling the solder present on exposed portion(s) 85 and/or 185.

In some embodiments, portion 75 is removed as follows. First, device 10 is heated under conditions sufficient to melt layer 60 without substantially melting layers 31 and 51 (see discussion above). When layer 60 is melted, portion 75 is peeled back from device 10, and then scored (cut through) to leave exposed portion 85 of layer 20. Portion 175 is removed from tape 120 in a similar fashion. Using this approach, exposed portions 85 and 185 can be formed at any desired locations along the length of a superconducting device. This can provide, for example, good flexibility in removing damaged portions of a superconducting device, easy removal and/or replacement of portions of damaged superconducting cable or wire, easy increase and/or decrease in the length of a superconducting cable or wire, and/or easy formation of a termination to a non-superconducting electrical contact.

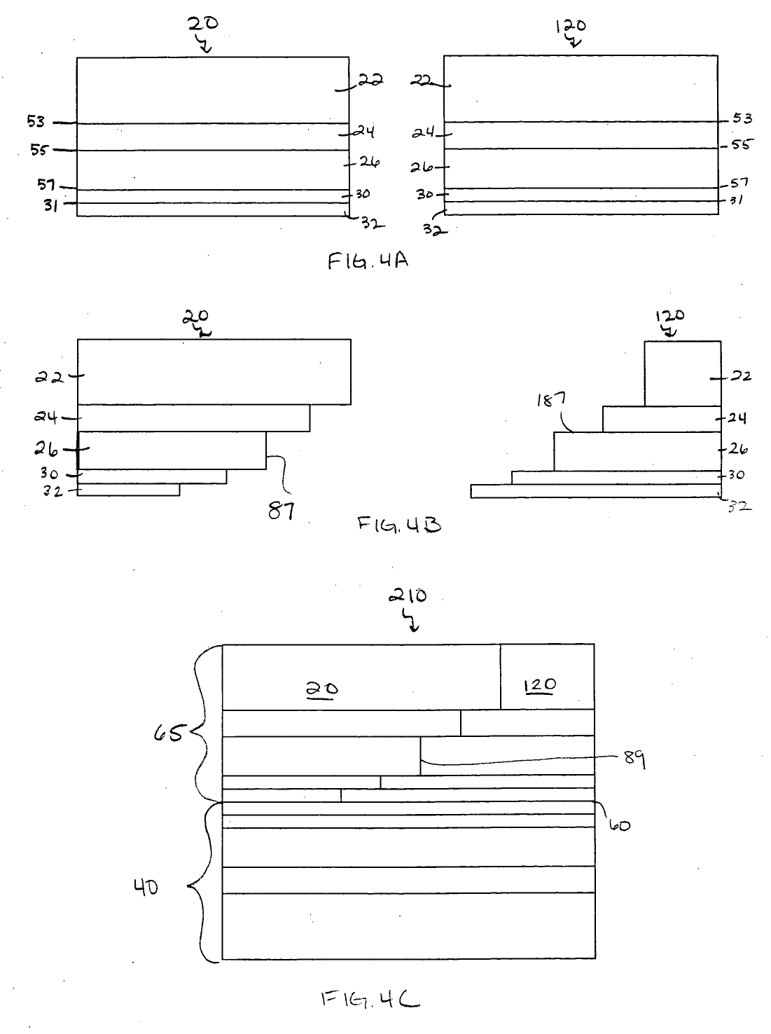

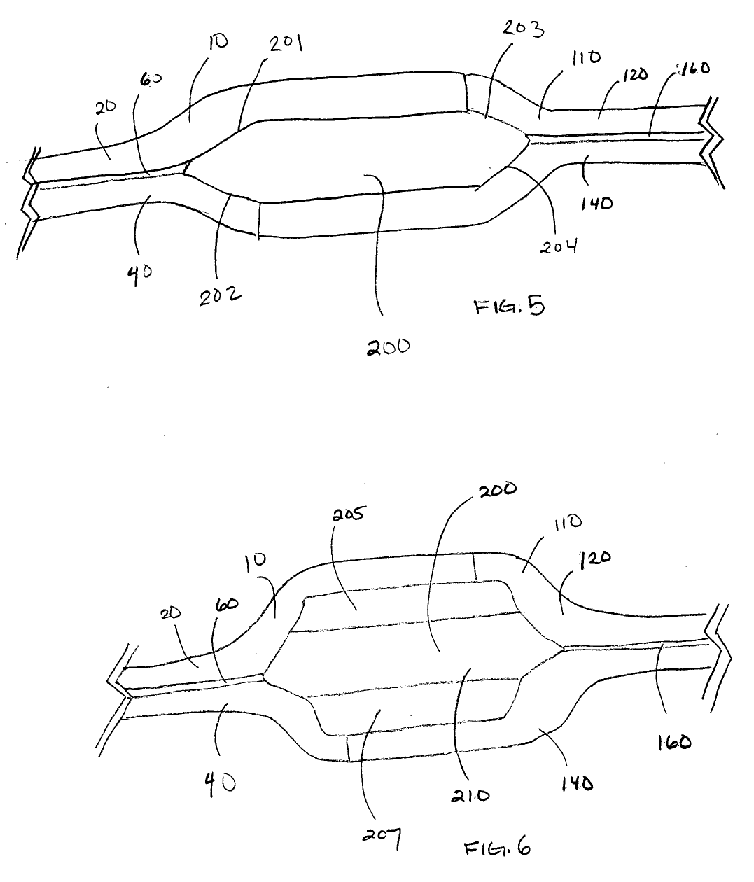

FIGS. 4A-4C show an embodiment of a method of joining tapes 20 and 120. Tapes 20 and 120, which each include solder layers 53, 55, 57, and 31, are joined together to form tape 65. Tape 65 is then releasably bonded to tape 40 via solder layer 60 to form device 210.

In general, the materials used to form solder layers 53, 55, 57, and 31 each have a melting point temperature greater than the material used to form solder layer 60. Layers 53, 55, 57, and 31 can be formed from the same or different materials (e.g., each layer can have the same melting point, each layer can have a different melting point). In some embodiments, the materials are selected so that each layer can be released from a neighboring layer at a different temperature.

Generally, to combine tapes 20 and 120, each of the tapes is heated to soften solder layers 53, 55, 57, and 31. Then portions of layers 32, 30, 26, and 24 are pulled back and scored to leave exposed portion 87 of layer 20. Corresponding portions on tape 120 are similarly removed to create exposed portion 187. Tapes 20 and 120 including the exposed portions 87 and 187 are then combined and joined to tape 40 via layer 60 to form device 210, having a stepped interface 89 as shown in FIG. 4C.

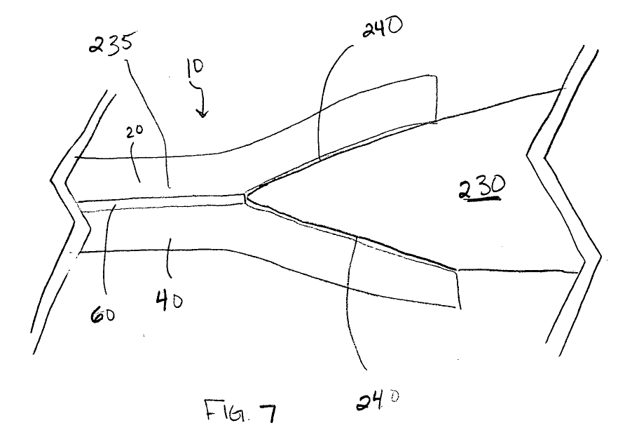

FIG. 5 shows an alternative arrangement for a splice in which an electrically conducting element 200 is disposed between joined devices 10 and 110. The separated or unbonded portions of tapes 20, 40 are bonded (e.g., soldered) to element 200 along surfaces 201 and 202 of element 200, respectively. Likewise, the unbonded portions of tapes 120 and 140 are bonded (e.g., soldered) to element 200 along surface 203 and 204 of element 200, respectively. Element 200 can help provide mechanical stability at a splice location and/or help increase the current carrying capabilities of the splice by providing an electrically conductive material that is in electrical communication with each of the tapes 20, 40, 120, and 140. An example of a material typically used as to form element 200 is any high conductivity metal (e.g., in the form of a strip), such as copper and silver. Another example of a material that can be used to form element 200 is a superconducting device (e.g., in the form of a tape) that includes at least one superconducting layer that is positioned in electrical contact with tapes 20, 40, 120, and/or 140. Although shown in FIG. 5 as having a particular geometric design, typically with tapered ends, it is to be understood that element 200 can have any desired geometric design (e.g., triangular cross-section, square cross-section, rectangular cross-section, diamond cross-section, trapezoid cross-section).

FIG. 6 shows an arrangement in which element 200 is formed of an electrically conductive element 210 disposed between superconducting devices 205 and 207, which, in turn, are disposed between devices 10 and 110. In general, devices 205 and 207 are designed so that an electrically conducting surface of device 205 is adjacent layers 20 and 120 (e.g., soldered to layers 20 and 120), and so that an electrically conducting surface of device 207 is adjacent layers 40 and 140 (e.g., soldered to layers 40 and 140). In some embodiments, devices 205 and 207 have an architecture that is similar to coated superconductor 10. In certain embodiments, devices 205 and 207 have an architecture that is similar to device 110. Superconducting devices 205 and 207 can increase the current carrying capability of the adjacent splice regions because the element 200 includes a superconducting material.

FIG. 7 shows an arrangement in which device 10 is connected to a terminal 230, which can be a non-superconducting contact termination for the superconducting device 10. To attach device 10 to terminal 230, at least a portion of the releasable bond along interface 60 is removed by heating and/or pulling back one of tape 20, 40 (see discussion above). After a portion of the bond has been removed, tape 40 is bonded (e.g., soldered) to tape 20 in a first region 235 of device 10 and is unbonded to tape 20 in a second region 240. Terminal 230, which is electrically conducting, is then inserted in between (i.e., disposed within the second region 240) and bonded (e.g., soldered) to be in electrical communication with both tapes 20, 40. Although shown in FIG. 7 as having a particular geometric design, it is to be understood that terminal 230 can have any desired geometric design (e.g., triangular cross-section, square cross-section, rectangular cross-section, diamond cross-section, trapezoid cross-section). The connection to the terminal can also be made with only one contact surface, for example, with only tape 20. This configuration may have lower current capacity, but may be made flat without a tapered termination end.

In some embodiments, the substrate/buffer layer(s)/superconducting layer arrangement of a superconducting device is formed via epitaxial growth. For example, an alloy substrate, such as a nickel tungsten alloy, is formed by heating and annealing to obtain the desired texture. The buffer layer(s) are then epitaxially vapor deposited or solution deposited on the textured surface of the substrate, followed by epitaxial vapor deposition or solution deposition of the superconducting layer. Examples of methods of forming a coated superconductor are described in U.S. patent application Ser. No. 09/617,518, entitled “Enhanced High Temperature Coated Superconductors,” which is hereby incorporated by reference.

In certain embodiments, buffer layer 24 and/or 44 is formed using ion beam assisted deposition (IBAD). In some IBAD processes, buffer layers 24 and 44 are deposited epitaxially on an amorphous substrate 22 and 42, respectively, while an ion beam is directed on the amorphous substrate to achieve a textured deposition. This technique is described in U.S. Pat. No. 6,190,752 and entitled “Thin Films Having a Rock-Salt Like Structure Deposited on Amorphous Surfaces,” which is hereby incorporated by reference. In other IBAD processes, the amorphous substrate is not necessary.

While certain embodiments have been described, other embodiments are possible.

As an example, a layer used to bond two superconducting tapes together or used to bond a superconducting tape to an electrically conductive element (see discussion above) can be formed of an electrically conducting paste (e.g., a metallic paste, such as a silver paste), rather than a solder. In such embodiments, the paste can be removed by exposure to an appropriate chemical agent (e.g., a solution capable of dissolving the paste, such as acetone).

In some embodiments in which two superconducting tapes are bonded by a metallic paste, the bond formed between the tapes can be removed by pulling the two tapes apart without applying any chemical agents. For example, the metallic paste can be formed from small metallic particles suspended within an alcohol such that the paste is relatively weak (relatively low mechanical strength) in the c-axis (e.g., compared to the mechanical strength that a solder layer provides), thereby allowing the tapes to be separated by pulling the tapes apart (e.g., without heating, without using a solvent).

As an additional example, a solder layer (e.g., layer 60, layer 31, and/or layer 51) can include a thin easily soluble net. The net can be dissolved by chemical treatment, thereby releasing the layer (e.g. layer 60) without substantially affecting layers 31 or 51 or the performance of the superconducting layers.

As an additional example, in certain embodiments, electrical connections between layers 20 and 40 are not present. In this case a non-metallic layer, for instance a polymer, epoxy or other bonding layer may be used such that the layer either burns off at about a predetermined temperature, which is below the melting temperature of layers 31 and 51, or dissolves in a solvent or acid that does not affect layers 31 and 51.

As another example, substrate 22 and/or 42 can be formed of materials other than nickel-tungsten alloys. For example, substrates 22 and 42 can be formed from substantially non-magnetic metals or substantially non-magnetic metal alloys. Examples of materials typically used to form substrates 22 and 42 include nickel, silver, zinc, copper, aluminum, iron, chromium, vanadium, palladium, molybdenum, and their alloys.

As a further example, while layers 24 and 44 are described as being buffer layer stacks, layer 24 and/or 44 can be formed of a single layer of a buffer material. In general, layers 24 and 44 each include at least one layer (or for example, at least two layers, at least three layers, at least four layers) of buffer material. Examples of buffer materials include metals and/or metal oxides, such as, silver, nickel, CeO₂, Y₂O₃, TbOₓ, GaOₓ, yttria stabilized zirconia (YSZ), LaAlO₃, SrTiO₃, Gd₂O₃, LaNiO₃, LaCuO₃, NdGaO₃, NdAlO₃, MgO, AlN, NbN, TiN, VN, and ZrN.

As an additional example, superconducting layers have been described as being formed of YBCO, other high temperature superconductors (HTS) which have superconducting transition temperatures of about 30 Kelvin can also be used. Such HTS materials can include YBa₂Cu₃O₇ and other rare earth oxide superconductors (e.g., GdBCO and ErBCO). Other examples of HTS materials include BiSrCaCuO, TlBaCaCuO, and HgBaCaCuO families, and MgB₂.

As an additional example, in certain embodiments, a coated superconductor can be formed without any buffer layers (e.g., with the superconducting layer disposed directly on the substrate).

As a further example, in certain embodiments, layer 31 and/or 51 is not present in the coated superconductor. In such embodiments, layers 30/32 and/or 50/52 can be, for example, sonically bonded together or thermally bonded together. Alternatively, layer 32 and/or 52 can be directly deposited on to layers 30 and/or 50, respectively.

As another example, while layers 30 and 50 have been described as being formed of silver, other electrically conductive materials (e.g., palladium, nickel, copper) and or metal oxides can be used.

As an additional example, while layers 32 and 52 have been described as being formed of copper, other electrically conductive materials (e.g., nickel, silver, or gold) can be used.

As a further example, while layers 30 and 32 have been described as being formed of the different material, in some embodiments, layer 30 and 32 are formed of the same material. Similarly, while layers 50 and 52 have been described as being formed of different material, in certain embodiments, layer 50 and 52 are formed of the same material.

As another example, while the corresponding components of adjacent coated superconductors have been described as being formed of the same material, corresponding components of adjacent coated conductors can be formed of different materials. In some embodiments, substrates 22 and 42 are formed of different materials. In certain embodiments, buffers layer(s) 24 and 44 are formed of different materials. In some embodiments, superconducting layers 26 and 46 are formed of different materials.

As a further example, tape 20 can include multiple metal layers in place of silver layer 30 and copper layer 32. Alternatively, in some embodiments, tape 20 can include a single metal layer that replaces both silver layer 30 and copper layer 32. The single metal layer can be vapor deposited, thermally bonded, or sonically bonded to superconducting layer 26.

### EXAMPLE I

A multi-layer superconducting device including two coated superconductor tapes was prepared as follows.

Each of the two coated superconductor tapes were prepared as follows.

A biaxially-textured 95 atomic percent nickel/five atomic percent tungsten alloy substrate was prepared by cold rolling and annealing in the form of a tape (75 micrometers thick and 1 centimeter wide).

Epitaxial buffer layers were sequentially deposited to form a stack with the structure substrate Ni/Y₂O₃/YSZ/CeO₂. The Ni layer (3 microns thick) was deposited by dc sputtering. The Y₂O₃ seed layer (50 nanometers thick) was deposited by electron beam evaporation. Both the YSZ barrier layer (300 nanometers thick) and the CeO₂ layer (30 nanometers thick) were deposited using RF sputtering.

A copper propionate, barium trifluoroacetate, yttrium trifluoroacetate based solution was slot-die coated onto the CeO₂ layer. The film was dried at 60° C. in humid air, and the resulting material was decomposed in a humid, oxygen atmosphere at a temperature up to 400° C., to a barium fluoride-based precursor film with stoichiometric amounts of copper and yttrium for subsequent YBCO formation.

The YBCO film (1 micron thick) was then grown from the precursor by passing the tape continuously through a tube furnace. The tape was oxygenated in 100% oxygen at 550° C. for 20 minutes with a 50° C./min cool to 200° C. followed by an uncontrolled cool to room temperature.

A 3 micron thick silver layer was deposited by dc sputtering on the surface of the YBCO layer.

The tape was oxygenated again in 100% oxygen at 550° C. in the tube furnace for 20 minutes. The tape was then cooled at a rate of 50° C./min to 200° C. followed by an uncontrolled cool to room temperature.

The silver coated surface of the tape was then laminated in a continuous system to a 50 micron thick copper tape at 215° C. using Sn 62 wt %/Pb 36 wt %/Ag 2 wt % solder having a melting temperature of 179° C.

One tape was 10 centimeters long, and the other tape was 14 centimeters long. Both tapes were one centimeter wide and a 0.15 millimeter thick. One tape had an individual critical current (measured before being joined with the other tape) of 133 Amperes as measured at 77K (self field), and the other tape had an individual critical current (measured before being joined with the first tape) of 144 Amperes as measured at 77K (self field).

The tapes were releasably joined together by coating the copper surfaces of each tape with a Bi 56 wt %/Pb 22 wt %/Sn 22 wt % solder manufactured by Indium Corporation of America (Utica, N.Y.) having a melting temperature of 104° C. and then pressing them together for 3 minutes with a heated clamp at 138° C. The tapes were arranged such that the centers of each tape were aligned (i.e., the second tape extended two centimeters further than the each of the ends of the first tape.) The releasably joined tapes, forming the device, had a critical current of 283 A as measured over the center 5 centimeters at 77K (self field).

In preparation for splicing, the device was heated to 138° C. to allow for the separation of the two tapes. Once the Bi 56 wt %/Pb 22 wt %/Sn 22 wt % solder holding the two tapes together softened, a portion of the first tape, which was about 6 centimeters long, was pulled away from the second tape. Then, this 6 centimeter long segment was cut from the first tape, and a 6 centimeter long segment was cut from the second tape, thereby forming a connection site located on the second tape that had an exposed surface that was 2 centimeters long and 1 centimeter wide.

The device having the 2 centimeter long connection site located on the second tape was then joined to a second device that included two coated superconducting tapes and a 2 centimeter connection site located on a first tape to complete the splice. The two devices were united by coating the copper surface side of each connection site with Bi 56 wt %/Pb 22 wt %/Sn 22 wt % solder followed by heating and pressing together the two devices at 138° C. After the two devices were united together, the critical current measured over the center 5 centimeters had a value of 78 Amperes as measured at 77K (self field).

### Example II

A multi-layer superconducting device including three coated superconductor tapes was prepared as follows.

Each of the three coated superconductor tapes were prepared as follows.

A biaxially-textured 95 atomic percent nickel/five atomic percent tungsten alloy substrate was prepared by cold rolling and annealing in the form of a tape (75 micrometers thick and 1 centimeter wide).

Epitaxial buffer layers were sequentially deposited to form a stack with the structure substrate Ni/Y₂O₃/YSZ/CeO₂. The Ni layer (3 microns thick) was deposited by dc sputtering. The Y₂O₃ seed layer (50 nanometers thick) was deposited by electron beam evaporation. Both the YSZ barrier layer (300 nanometers thick) and the CeO₂ layer (30 nanometers thick) were deposited using RF sputtering.

A copper propionate, barium trifluoroacetate, yttrium trifluoroacetate based solution was slot-die coated onto the CeO₂ layer. The film was dried at 60° C. in humid air, and the resulting material was decomposed in a humid, oxygen atmosphere at a temperature up to 400° C., to a barium fluoride-based precursor film with stoichiometric amounts of copper and yttrium for subsequent YBCO formation.

The YBCO film (1 micron thick) was then grown from the precursor by passing the tape continuously through a tube furnace. The tape was oxygenated in 100% oxygen at 550° C. for 20 minutes with a 50° C./min cool to 200° C. followed by an uncontrolled cool to room temperature.

A 3 micron thick silver layer was deposited by dc sputtering on the surface of the YBCO layer.

The tape was oxygenated again in 100% oxygen at 550° C. in the tube furnace for 20 minutes. The tape was then cooled at a rate of 50° C./min to 200° C. followed by an uncontrolled cool to room temperature.

The silver coated surface of the tape was then laminated in a continuous system to a 50 micron thick copper tape at 215° C. using Sn 62 wt %/Pb 36 wt %/Ag 2 wt % solder having a melting temperature of 179° C.

One of the tapes was 10 centimeters long, and the other tape was 14 centimeters long. Both of the tapes were one centimeter wide and a 0.15 millimeter thick. One of the tapes had an individual critical current (measured before being joined with the other tape) of 133 Amperes as measured at 77K (self field), and the other tape had an individual critical current (measured before being joined with the first tape) of 144 Amperes as measured at 77K (self field).

The tapes were releasably joined together by coating the copper surfaces of each tape with a Bi 56 wt %/Pb 22 wt %/Sn 22 wt % solder manufactured by Indium Corporation of America (Utica, N.Y.) having a melting temperature of 104° C. and then pressing them together for 3 minutes with a heated clamp at 138° C. The tapes were arranged such that the centers of each tape were aligned (i.e., the second tape extended two centimeters further than the ends of the first tape.) The releasably joined tapes, forming the device, had a critical current of 283 A as measured over the center 5 centimeters at 77K (self field).

In preparation for splicing, the device was heated to 138° C. to allow for the separation of the two tapes. Once the Bi 56 wt %/Pb 22 wt %/Sn 22 wt % solder holding the two tapes together softened, a portion of the first tape, which was about 6 centimeters long, was pulled away from the second tape. Then, this 6 centimeter long segment was cut from the first tape. A 6 centimeter long segment of a third tape was then spliced to the first tape, such that the combined length of the first tape and the third tape was 10 centimeters.

The third tape was united to the device by coating the copper surface side of each of the third tape and the second tape with Bi 56 wt %/Pb 22 wt %/Sn 22 wt % solder followed by heating and pressing together the two devices at 138° C. After the two devices were united together, the critical current measured over the center 5 centimeters had a value of 167 Amperes as measured at 77K (self field).

Other embodiments are in the claims.

1. A superconducting device comprising:
a first coated superconductor, comprising:
a first superconductor layer; and
a first metal layer supported by the first superconductor layer; and
a second coated superconductor releasably bonded to the first metal layer;
wherein heating the superconducting device to at least about a predetermined temperature releases the first metal layer from the second coated superconductor without releasing the first metal layer from the first superconductor layer.

2. The superconducting device of claim 1, wherein a critical current density of the first coated superconductor remains substantially unchanged after heating the superconducting device to at least about the predetermined temperature.

3. The superconducting device of claim 2, wherein a critical current density of the second coated superconductor remains substantially unchanged after heating the superconducting device to at least about the predetermined temperature.

4. The superconducting device of claim 1, wherein
the first coated superconductor comprises:
a first non-superconductor layer supporting the first superconductor layer; and
the second coated superconductor comprises:
a second non-superconductor layer;
a second superconductor layer supported by the second non-superconductor layer; and
a second metal layer supported by the second superconductor layer.

5. The superconducting device of claim 4, wherein the first metal layer is bonded to the first superconductor layer with an electrically conducting bond.

6. The superconducting device of claim 4, wherein the first metal layer is soldered to the first superconductor layer.

7. The superconducting device of claim 1, wherein the first metal layer is bonded to the first superconductor layer using a method selected from a group consisting of vapor deposition, sonically bonding, and thermally bonding.

8. The superconducting device of claim 4, wherein each of the first and second metal layers comprise multiple layers.

9. The superconducting device of claim 8, wherein a first layer of the multiple layers comprises silver and a second layer of the multiple layers comprises copper.

10. The superconducting device of claim 9, wherein the multiple layers are thermally bonded to each other.

11. The superconducting device of claim 9, wherein the multiple layers are sonically bonded to each other.

12. The superconducting device of claim 9, wherein the multiple layers are bonded to each other with a first solder.

13. The superconducting device of claim 12, wherein the first metal layer of the first coated superconductor and the second metal layer of the second coated superconductor are releasably bonded to each other with a second solder.

14. The superconducting device of claim 13, wherein a melting temperature of the second solder is at least about 5° C. lower than a melting temperature of the first solder.

15. The superconducting device of claim 13, wherein a melting temperature of the second solder is at least about 10° C. lower than a melting temperature of the first solder.

16. The superconducting device of claim 13, wherein a melting temperature of the second solder is at least about 15° C. lower than a melting temperature of the first solder.

17. The superconducting device of claim 13, wherein a melting temperature of the second solder is 25° C. lower than a melting temperature of the first solder.

18. The superconducting device of claim 4, wherein the first non-superconductor layer comprises a substrate.

19. The superconducting device of claim 18, wherein the substrate is a nickel alloy.

20. The superconducting device of claim 19, wherein the nickel alloy comprises Ni—W.

21. The superconducting device of claim 18, wherein at least one buffer layer is deposited on the substrate.

22. The superconducting device of claim 4, wherein the first superconducting layer comprises a high temperature superconductor with a transition temperature above about 30 Kelvin.

23. The superconducting device of claim 22, wherein the first superconducting layer comprises a rare earth oxide.

24. The superconducting device of claim 4, wherein the first superconducting layer comprises YBa₂Cu₃O₇₋ₓ where x is a number greater than 0 but less than 1.

25. The superconducting device of claim 4, wherein the first superconducting layer comprises YBa₂Cu₃O₇.

26. The superconducting device of claim 4, wherein the first superconducting layer comprises YBa₂Cu₃O_{6.7}.

27. A superconducting device comprising:
a first coated superconductor; and
a second coated superconductor releasably bonded to the first coated superconductor;
wherein subjecting the superconducting device to a solution formulated to dissolve a bond between the first and second coated superconductors releases the first coated superconductor from the second coated superconductor.

28. The superconducting device of claim 27, wherein a critical current density of the first coated superconductor remains substantially unchanged after subjecting the superconducting device to the solution.

29. The superconducting device of claim 28, wherein a critical current density of the second coated superconductor remains substantially unchanged after subjecting the superconducting device to the solution.

30. The superconducting device of claim 29, wherein the second coated superconductor is releasably bonded to the first coated superconductor with a metallic paste.

31. A method of splicing superconducting devices, comprising:
providing a first superconducting device, the first superconducting device including a first coated superconductor releasably bonded to a second coated superconductor;
providing a second superconducting device including a third coated superconductor releasably bonded to a fourth coated superconductor;
removing a first length of the second coated superconductor;
removing a complementary length of the third coated superconductor; and
joining the first and second superconducting devices to form an interface between the first coated superconductor and the fourth coated superconductor.

32. The method of claim 31, wherein the interface is electrically conductive.

33. The method of claim 31, wherein heating the first superconducting device to at least about a predetermined temperature releases the first coated superconductor from the second coated superconductor.

34. The method of claim 33, wherein heating the second superconducting device to at least about the predetermined temperature releases the third coated superconductor from the fourth coated superconductor.

35. The method of claim 33, wherein removing the first length of the second coated superconductor comprises:
heating the first superconducting device to at least about the predetermined temperature to release at least a portion of the first coated superconductor from the second coated superconductor; and
cutting the second coated superconductor from an exposed surface of the second coated superconductor to an interface between the first and second coated superconductors to release a first length from the first superconducting device.

36. The method of claim 33, wherein removing the complementary length comprises:
heating the second superconducting device to at least about the predetermined temperature to release at least a portion of the third coated superconductor from the fourth coated superconductor; and
cutting the third coated superconductor from an exposed surface of the third coated superconductor to an interface between the third and fourth coated superconductors to release a complementary length from the second superconducting device.

37. The method of claim 31, wherein applying a chemical agent to the first superconducting device releases the first coated superconductor from the second coated superconductor.

38. A superconducting device, comprising:
a first coated superconductor;
a second coated superconductor, the second coated superconductor being bonded to the first coated superconductor in a first region of the superconducting device, the second coated superconductor being unbonded to the first coated superconductor in a second region of the superconducting device; and
an electrically conducting element disposed in the second region and in electrical communication with the first and second coated superconductors.

39. The superconducting device of claim 38, wherein the second coated superconductor is releasably bonded to the first coated superconductor in the first region.

40. The superconducting device of claim 38, wherein the electrically conducting element comprises metal.

41. The superconducting device of claim 40, wherein the electrically conducting element comprises copper.

42. The superconducting device of claim 38, wherein the electrically conducting element comprises a superconducting article.

43. The superconducting device of claim 38, wherein the electrically conducting element has a cross-sectional shape selected from the group consisting of triangle, diamond, square, rectangle, hexagon, trapezoid, and any combination thereof.

44. The superconducting device of claim 38, further comprising:
a third coated superconductor; and
a fourth coated superconductor, the fourth coated superconductor being bonded to the third coated superconductor in a third region of the superconducting device, the fourth coated superconductor being unbonded to the third coated superconductor in the second region of the superconducting device.

45. The superconducting device of claim 44, wherein the electrically conducting element is in electrical communication with the third and fourth coated superconductors in the second region.

46. The superconducting device of claim 45, wherein the electrically conducting element comprises metal.

47. The superconducting device of claim 45, wherein the first coated superconductor is in contact with the third coated superconductor in the second region.

48. The superconducting device of claim 47, wherein the second coated superconductor is in contact with the fourth coated superconductor in the second region.

49. The superconducting device of claim 48, wherein in the second region the first coated superconductor has a greater length than the second coated superconductor.

50. The superconducting device of claim 45, wherein the electrically conducting element comprises:
a metal element; and
at least one superconducting article in electrical communication with the metal element.

51. The superconducting device of claim 50, wherein the at least one superconducting article is in electrical communication with the first and third coated superconductors.

52. The superconducting device of claim 51, wherein the at least one superconducting article is in electrical communication with the second and fourth coated superconductors.

53. A method of cutting a superconducting device comprising a first superconductor and a second superconductor releasably bonded to the first superconductor, the method comprising:
cutting the superconducting device so that the first coated superconductor, the second coated superconductor, and an interface between the first and second coated superconductors are exposed;
heating the first superconductor to at least about a predetermined temperature so that a first length of first coated superconductor releases from the second coated superconductor; and
removing the first length from the first coated superconductor so that an end of the first coated superconductor is offset from an end of the second coated superconductor.

54. The method of claim 53, wherein a second length of the second coated superconductor is removed from the superconducting device, the second length being less than the first length.

55. The method of claim 53, wherein a critical current density of the first coated superconductor remains substantially unchanged after heating the superconducting device to at least about the predetermined temperature.

56. The method of claim 55, wherein a critical current density of the second coated superconductor remains substantially unchanged after heating the superconducting device to at least about the predetermined temperature.

57. A superconducting device comprising:
a first coated superconductor;
a second coated superconductor; and
a metallic paste,
wherein the metallic paste releasably bonds the first coated superconductor to the second coated superconductor to form an interface therebetween.

58. The superconducting device of claim 57, wherein a critical current density of each of the first and second coated superconductors remains substantially unchanged after peeling a portion of the first superconductor away from the interface.

59. The superconducting device of claim 58, wherein the metallic paste is silver paste.

60. A method of joining a first coated superconductor to a second coated superconductor,
the method comprising:
removing a first portion of a first metallic layer, the first metallic layer being releasably bonded to the first coated superconductor;
removing a complementary portion of the second coated superconductor;
removing a second portion of the first coated superconductor;
removing a complementary portion of a second metallic layer, the second metallic layer being releasably bonded to the second coated superconductor;
joining the first and second coated superconductors such that a stepped interface is formed therebetween.

61. A superconducting device comprising:
a first article comprising:
a first superconductor; and
a first metal layer releasably bonded to the first superconductor; and
a second article comprising:
a second superconductor; and
a second metal layer releasably bonded to the second superconductor, wherein the first article is joined to the second article along a stepped interface.

62. The superconducting device of claim 61, wherein the first metal layer comprises multiple metal layers.

63. The superconducting device of claim 52, wherein the second metal layer comprises multiple metal layers.

64. The superconducting device of claim 63, further comprising a first non-superconducting layer bonded to the first coated superconductor.

65. The superconducting device of claim 63, further comprising a second non-superconducting layer bonded to the second coated superconductor.
